(19) United States
(12) Patent Application Publication
(10) Pub. No.: US 2005/0124182 A1
(43) Pub. Date: Jun. 9, 2005

(54) Guidance block

(76) Inventors: Lambert Simonovich, Stittsville (CA); Joseph J. Lommen, Nepean (CA); Sebastien Nadeau, Gatineau (CA); David A. McQuinn, Ottawa (CA)

Correspondence Address: ALAN M WEISBERG;CHRISTOPHER & WEISBERG, 200 EAST LAS OLAS BOULEVARD, SUITE 2040, FORT LAUDERDALE, FL, 33301, US

(21) Appl. No.: 10/732,604

(22) Filed: Dec. 9, 2003

(51) Int. Cl. H01R 12/00

(52) U.S. Cl. 439/66

(57) ABSTRACT

A guidance block includes a base, a pair of opposing card guide sides supported on a common surface of the base, the sides defining a gap between the pair of opposing sides, and a spring coupled to one of the card guide sides, partially within the gap provided between the pair of opposing sides, with the card guide sides and spring member configured to align a circuit board disposed in the gap with a connector.

### BACKGROUND

A backplane or midplane (hereafter called backplane) is an electronic circuit board, which may include circuits, and includes sockets into which other circuit boards or cards can be plugged. For instance, in a computer the backplane (sometimes referred to as a motherboard) is a circuit board that includes sockets for cards. The cards (also referred to as expansion cards, boards, adapters and so forth) include circuits that provide a functional capability to the computer. The card is typically made of a rigid material and is plugged into one of the computer's expansion slots e.g., connectors in the backplane. Cards have a variety of sizes designed to match corresponding socket dimensions. To provide alignment of the card to the slot, the backplane can include a guide pin and the card can include a receptacle. Inserting the guide pin into the receptacle aligns the card with the slot.

### SUMMARY OF THE INVENTION

In one aspect the invention features a guidance block that includes a base and a pair of opposing card guide sides supported on a common surface of the base. The opposing card sides define a gap between the pair of opposing sides. A spring member is coupled to one of the card guide sides, partially within the gap provided between the pair of opposing sides, with the card guide sides and spring clip configured to align a circuit board disposed in the gap between with a connector.

Embodiments may include one or more of the following. The base can be connected to a backplane or a midplane. The base can include an extension region. The extension region can be configured to fit into an alignment slot in the backplane. The card guide side can include a spring region configured to attach the spring. The spring region can include an overhang member. The card guide sides can be configured such that the spring can be coupled to either of the sides. The card guide sides can include a macro alignment region. The macro alignment region can include an angled end. The guidance block can include screws that attach the base to the backplane. The spring can provide alignment of a primary side of the circuit board.

The sides can be configured to accept multiple thicknesses of circuit packs. The spring clip can include an electrically conductive material that provides an electrostatic discharge (ESD) path to ground. The base can include an angled outer region.

In another aspect, the invention features a device that includes a backplane and a guidance block. The guidance block includes a base, a pair of opposing card guide sides supported on a common surface of the base. The opposing card guide sides define a gap between the pair of opposing sides. A spring member is coupled to one of the card guide sides, partially within the gap provided between the pair of opposing sides. The card guide sides and spring clip are configured to align a circuit board disposed in the gap with a connector.

Embodiments may include one or more of the following. The base can include an extension region configured to fit into an alignment slot in the backplane. The card guide side can include a spring region configured to attach the spring. The spring region can include an overhang member. The card guide sides can be configured such that the spring can be coupled to either of the sides. The card guide sides can include a macro alignment region having an angled end. The spring can provide alignment of a primary side of the circuit board. The sides can accept multiple thicknesses of circuit boards. The spring clip can be composed of an electrically conductive material. The base can include an angled outer region

In one aspect, the guidance block includes a spring to bias a card to the primary side of the guidance block. This allows a user to insert a board into the device without regard for the thickness of the board. The spring aligns the connectors on the board with the connectors in the slot.

In another aspect, guidance blocks are provided in pairs. Providing the guidance blocks in pairs adds the advantage of both horizontal and vertical alignment of the card to the socket.

The current invention obviates the need for the traditional guide pin and receptacle to provide macro alignment of a card to a slot. The current invention does not require additional printed circuit board (PCB) real estate for a guide pin receptacle and maximizes the height of the PCB's. This allows greater I/O density per card since the space traditionally needed for a guide receptacle can be used for additional connectors.

### DESCRIPTION OF DRAWINGS

FIG. 1 is a diagram depicting a backplane with a guidance block.

FIG. 2 is a diagram a guidance block.

FIG. 3 is a diagram of the spring attachment region of the guidance block and a spring.

### DESCRIPTION

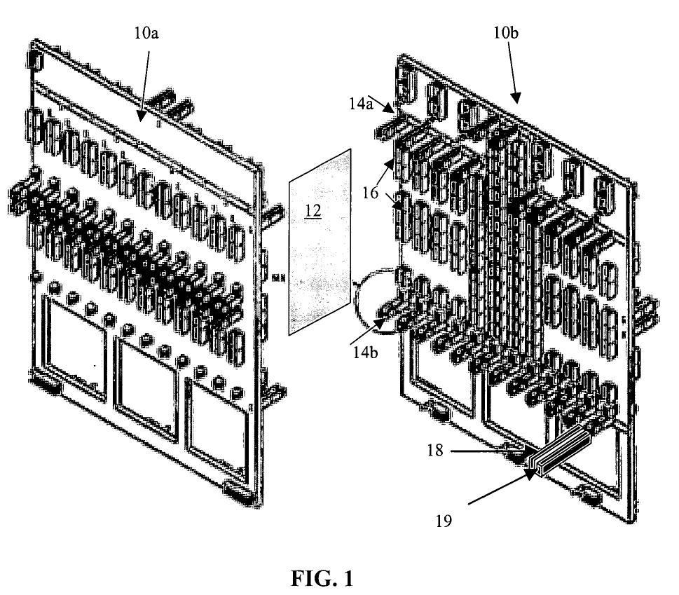

Referring to FIG. 1, a backplane 10 includes multiple slots 16. A user aligns and plugs a card 12 into one of the slots 16. Each slot 16 fits a particular card thickness. Typical card thicknesses range from 0.05 inches to 0.20 inches. The shelf may include shelf card guides 18. The shelf card guides 18 have slots 19 configured to accept the card, and are usually part of the shelf mechanical assembly. Alternately, guidance blocks 14 attached to the backplane 10 provide macro alignment of the card 12 to the slot 16 and can be easier to use than the shelf card guides 18 included in the backplane 10. Each guidance block 14 includes a slot configured to accept the edge of a card 12. For example, guidance block 14a guides a first edge (depicted as the upper edge in FIG. 1) of a card 12 while guidance block 14b guides a second parallel edge (depicted as :the lower edge in FIG. 1) of the card 12. Using the guidance blocks in pairs, provides both horizontal and vertical alignment of the card to the sockets. The guidance blocks 14 can be removably attached to the backplane, for example by attaching the guidance blocks 14 to the backplane 10 using screws. Alternately, bonding, soldering, and so forth can permanently or semi-permanently attach the guidance blocks 14.

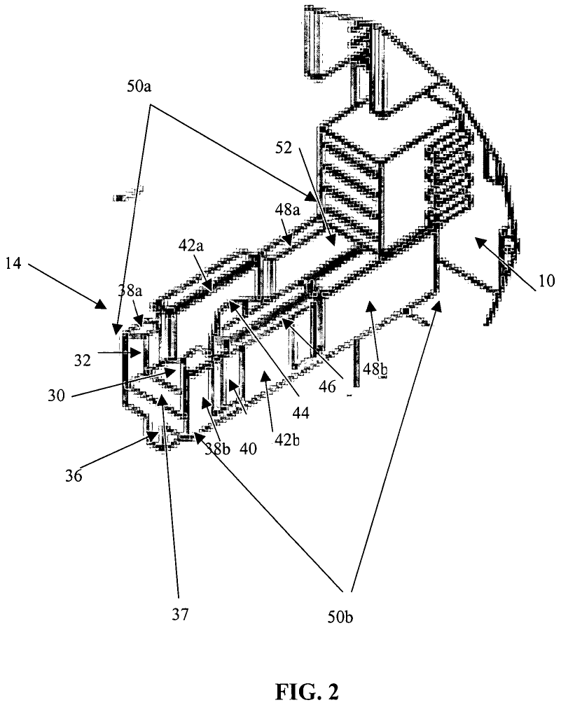

Referring to FIG. 2 guidance block 14 includes a base 30 and opposing perpendicular sides 50a and 50b forming a guide slot 52. Each side 50a and 50b includes three regions, a macro alignment region 38, a spring region 42, and an end region 48. The macro alignment region 38 includes a slanted outer region 32 used to guide the card horizontally into the guide slot 52. A slanted region 37 at the front edge of base 30 provides the ramping feature to vertically align the card 12 into slot 52. A spring clip 44 attaches to the spring region 42 of one of the sides 50a, 50b. Alternately, other types of spring members could be used instead of spring clip 44.

While the spring clip 44 provides the advantage of ease of manufacture and assembly, other types of spring members can be used. For example, a spring member could be composed of a coil spring with a flat plate attached for the sliding surface or a wire formed leaf spring, the spring could also be made of plastic and have an optional coating of a electrically conductive material.

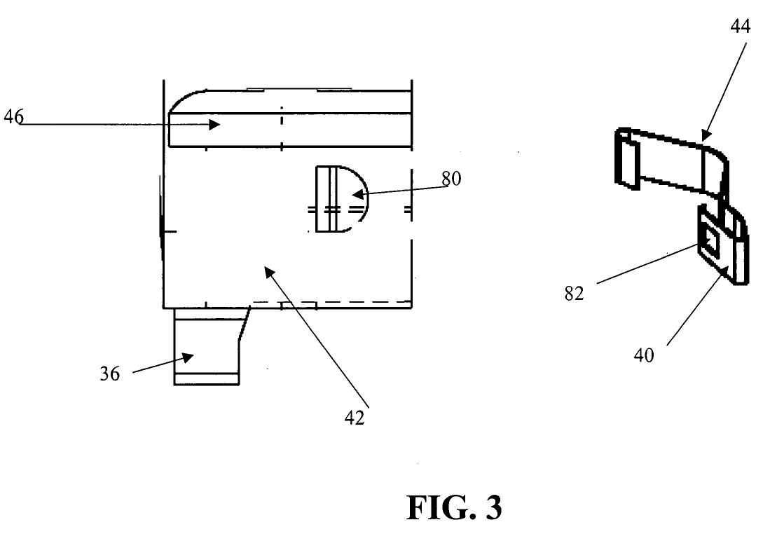

The spring clip 44 can be attached to either spring region 42a or 42b dependent on whether the guidance block 14 will be used as a top guidance block or bottom guidance block. In order to bias the card to the opposite side, the spring clip 44 is attached to the opposite spring region (i.e. attaching the spring to region 42a of side 50a biases the card towards side 50b). In this example (FIG. 2), the spring clip 44 is shown attached to spring region 42b. A curved, unshaped lip 40 portion of the spring clip 44 attaches the spring clip 44 to spring region 42b of the guidance block 14. Lip 40 extends around a side of spring region 42 (FIG. 3). The lip 40 includes an attachment hole 82 that snaps into a raised tab 80 on the spring region 42. The locking of the raised tab 80 into the attachment hole 82 secures the spring clip 44 to the spring region 42. Lip 40 extends around the side of spring region 42b. An overhang member 46 on the spring region 42 helps to hold the spring clip 44 in place. The overhang member 46 prevents the spring clip 44 from sliding vertically and detaching from the spring region 42.

Spring clip 44 provides horizontal alignment for the circuit pack and biases the card 12 toward side 50a (FIG. 2). This biasing aligns a connector on the primary side of a card 12 to a connector in the backplane 10. Since the spring clip 44 can be depressed in varying amounts and slot 52 is wider than the board, guidance block 14 can accept cards 12 of varying thickness. Since guidance block 14 can accept cards 12 of varying thicknesses, a guidance block 14 can be used with a backplane without concern for the card thickness the backplane is configured to accept. The spring clip 44 can be made of an electrically conductive material, for example beryllium copper stainless steel, spring steel, copper, or aluminum. In another example the spring clip can be made of plastic provided the plastic acts as a spring, moves the card, and returns to its original position after deflection. When the spring clip 44 is composed of metal, and the guidance block 14 is composed of metal and the block is grounded, the metal provides an electrostatic discharge (ESD) path from the board to ground. If the spring was formed out of plastic it could be electro-plated to-provide the electrical path for grounding.

An extension 36 from base 30 fits the shelf card guides 18. A backplane is often configured to fit a particular card thickness. Thus, shelf card guide 18 may be included on the shelf to provide alignment of the card to the slot of the shelf. Since shelf card guide 18 is the approximate thickness of the board, it may be difficult for a user to align the board to the shelf card guide 18. A user slides the extension 36 on the guidance block 14 into the shelf card guide 18, thus the user can align the board using guidance block 14 instead of the shelf card guide 18 provided on the shelf. The spring clip 44 on guidance block 14 aligns the board, allowing the user to insert the card into a wider slot (slot 52) yet still align the card to the connectors.

In one example, the base 30 and sides 50 are molded from plastic producing a unitary piece having the features discussed above. Base 30 and sides 50 could instead be composed of multiple parts bonded together to form the structure. In another example, the base 30 and sides 50 could be composed of metal (providing ESD protection) or another firm, electrically conductive material.

The exact shape and attachment of spring clip 44 can vary. In the example shown in FIG. 2 and FIG. 3, the spring clip 44 is attached by extension region 40 of the spring using tab 80 and hole 82. The spring clip 44 could alternately be adhesively bonded to region 42.

While in the example described above, each guidance block 14 is individually attached to backplane 10, multiple guidance blocks 14 can be grouped to form a larger unit. For example, a backplane might include eight card slots. Thus, a grouping of sixteen guidance blocks (one top and one bottom per slot) 14 provides alignment for each card slot in the backplane.

In the above example, the guidance block 14 includes a single spring to bias the card. The guidance block 14 could alternately include two springs. In this example, each side would have opposing springs. By including two springs, the card is aligned not to one side, but to the middle of the guidance block 14.

A single part could be provided out of plastic that formed the ramp block and the spring as a single unit this could then be plated to provide the ground as well.

A number of embodiments of the invention have been described. Nevertheless, it will be understood that various modifications may be made without departing from the spirit and scope of the invention. Accordingly, other embodiments are within the scope of the following claims.

1. A guidance block comprising:
a base;
a pair of opposing card guide sides supported on a common surface of the base, the sides defining a gap between the pair of opposing sides; and
a spring member coupled to one of the card guide sides, partially within the gap provided between the pair of opposing sides, with the card guide sides and spring member configured to align a circuit board disposed in the gap with connector.

2. The guidance block of claim 1 wherein the base is connected to a backplane.

3. The guidance block of claim 1 wherein the base is connected to a midplane.

4. The guidance block of claim 1 wherein the base includes an extension.

5. The guidance block of claim 4 wherein the extension is configured to fit into a shelf card guide.

6. The guidance block of claim 1 wherein the card guide side includes a spring region configured to attach the spring member.

7. The guidance block of claim 6 wherein the spring region includes an overhang member.

8. The guidance block of claim 1 wherein the card guide sides are configured such that the spring member can be coupled to either of the card guide sides.

9. The guidance block of claim 1 wherein the card guide sides include a macro alignment region.

10. The guidance block of claim 1 wherein the spring member provides alignment of a primary side of the circuit board.

11. The guidance block of claim 1 wherein the card guide sides can accept multiple thicknesses of circuit boards.

12. The guidance block of claim 1 wherein the spring member includes an electrically conductive material.

13. The guidance block of claim 12 wherein the electrically conductive material of the spring clip provides an electrostatic discharge (ESD) path.

14. The guidance block of claim 1 wherein the base includes an angled outer region.

15. A device including:
a backplane; and
a guidance block, the guidance block including
a base;
a pair of opposing card guide sides supported on a common surface of the base, the sides defining a gap between the pair of opposing sides; and
a spring member coupled to one of the card guide sides, partially within the gap provided between the pair of opposing sides, with the card guide sides and spring clip configured to align a circuit board disposed in the gap with connector.

16. The device of claim 15 wherein the card guide side includes a spring region configured to attach the spring member.

17. The device of claim 16 wherein the spring region includes an overhang member.

18. The device of claim 15 wherein the card guide sides are configured such that the spring member can be coupled to either of the card guide sides.

19. The device of claim 15 wherein the card guide sides include a macro alignment region having an angled end.

20. The device of claim 15 wherein the spring member provides alignment of a primary side of the circuit board.

21. The device of claim 15 wherein the card guide sides can accept multiple thicknesses of circuit boards.

22. The device of claim 15 wherein the spring clip includes an electrically conductive material.

23. The device of claim 15 wherein the base includes an angled outer region
